(19) United States
(12) Patent Application Publication
(10) Pub. No.: US 2012/0254385 A1
(43) Pub. Date: Oct. 4, 2012

(54) Method and Apparatus for Passive Neighbor Unreachability Detection

(76) Inventor: Cahya A. Masputra, San Jose, CA (US)

(21) Appl. No.: 13/077,551

(22) Filed: Mar. 31, 2011

(51) Int. Cl. G06F 15/173

(52) U.S. Cl. 709/223

(57) ABSTRACT

A method and apparatus of a device that determines if an address is reachable based on the time the device has received a packet with the address of another device is described. The device receives a packet for transmission to the other device, where the packet includes an address of the second device. The device determines if that address is reachable based on a time that the device receives another packet from the second device. The device further receives another packet from the second device and stores the time the device received the other packet in a reachability record corresponding to that address.

### FIELD OF INVENTION

This invention relates generally to networking and more particularly to detecting the unreachability of neighbor devices in a network.

### BACKGROUND OF THE INVENTION

Devices in a computer network will have two different addresses assigned to them: a network layer address (e.g., an Internet Protocol (IP) address) and a link layer address (e.g., a Media Access Control (MAC) address). For one device to send a packet to another device, the sending device looks up the link layer address that corresponds to the network layer address for the receiving device. For example, the sending device looks up the corresponding MAC address for the receiving device in an Address Resolution Protocol (ARP) table. This table is used to maintain an association between IP and MAC address for known neighboring devices. If the corresponding link layer address is not found for a network layer address, the sending device will then broadcast a request to determine the corresponding link layer address for the network layer address. For example, the sending device broadcasts an ARP address request to neighboring devices to determine a MAC address that corresponds to an IP address. A neighboring device can answer the ARP request, using an ARP response packet as is known in the art.

A device maintains an association between the between the network layer address and a corresponding link layer address in a table. For example, a device uses an ARP table to include one or more ARP entries. Each entry maintains an association between a source IP and source MAC address. Each association is valid for a certain period of time, after which the association expires. Expiration times can range from a matter of seconds to twenty minutes. While the default is twenty minutes, the expiration period is configurable. In addition, static entries can be in the ARP table, where the association between the network layer address and the link layer address does not expire.

For devices, separated by router and the router has a route to the destination network of the receiving device, the corresponding link layer address for the receiving device is the router's link layer address. Thus, if a sending device wants to transmit a packet to a receiving device that is separated by a router, the sending device would use the IP address of the receiving device and the MAC address of the router. The router would receive the packet and forward that packet on the route towards the receiving address.

A problem occurs if a local area network includes two routers for remote network access, with an active router forwarding packets and the backup router on standby as a failover backup. In this arrangement, the two routers can have the same IP address but different MAC addresses. If there is silent failover from the active router to the backup router, there can be a disruption of traffic services because devices wishing to send packets across the routers would use the MAC address of the failed active router and not the backup router before the MAC address entry of the active router expires. This can last from a matter of seconds on upwards to twenty minutes. It would be useful for devices to include a mechanism for early detection of neighbor unreachability, so as to lessen the time of network disruption.

### SUMMARY OF THE DESCRIPTION

A method and apparatus of a device that determines if an address is reachable based on the time the device has received a packet with the address of another device is described. The device receives a packet for transmission to the other device, where the packet includes an address of the second device. The device determines if that address is reachable based on a time that the device receives another packet from the second device. The device further receives another packet from the second device and stores the time the device received the other packet in a reachability record corresponding to that address.

In a further embodiment, the device receives an address request announcement from the other device. This address request announcement includes a first address that is a network layer address and the second address is a link layer address. The device further locates an address request record corresponding to the first and second addresses. This address request record includes a field to reference a reachability record for the second address.

Other methods and apparatuses are also described.

### BRIEF DESCRIPTION OF THE DRAWINGS

The present invention is illustrated by way of example and not limitation in the figures of the accompanying drawings in which like references indicate similar elements.

FIG. 1A is a block diagram of one embodiment of system that is used to communicate packets from one device to a remote device.

FIG. 1B is a block diagram of one embodiment of system that is used to communicate packets from one device to a remote device after a switchover from one router to another router.

FIG. 1C is a block diagram of a network reachability module that is used to monitor and detect the unreachability of neighbor devices.

FIG. 2 is a flow diagram of one embodiment of a process to process address requests received by a first device.

FIG. 3 is a block diagram of an address request structure that references a reachability record.

FIG. 4 is a flow diagram of one embodiment of a process to release a reachability record.

FIG. 5 is a flow diagram of one embodiment of a process to receive a packet.

FIG. 6 is a flow diagram of one embodiment of a process to transmit a packet.

FIG. 7A is a block diagram of one embodiment of system that is used to communicate packets from one device after an address migration from one router to another router.

FIG. 7B is a block diagram of one embodiment of system that is used to communicate packets from one device after an address migration from one router to another router, where the backup router is active.

FIG. 8 is a block diagram of one embodiment of a receive address request module to process received address requests.

FIG. 9 is a block diagram of one embodiment of a release existing record module to release an existing reachability record.

FIG. 10 is a block diagram of one embodiment of a transmit packet module to transmit packets.

FIG. 11 is a block diagram of one embodiment of a receive packet module to process received packets.

FIG. 12 illustrates one example of a typical computer system, which may be used in conjunction with the embodiments described herein.

FIG. 13 shows an example of a data processing system, which may be used with one embodiment of the present invention.

### DETAILED DESCRIPTION

A method and apparatus of a device that determines if an address is reachable based on the time the device has received a packet with the address of another device. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

A method and apparatus of a device that determines if an address is reachable based on the time the device has received a packet with the address of another device is described. The device receives a packet for transmission to the other device, where the packet includes an address of the second device. The device determines if that address is reachable based on a time that the device receives another packet from the second device. This time can be stored in a reachability record that is reference by an address request record corresponding to the address. The device further receives another packet from the second device and stores the time the device received the other packet in the reachability record corresponding to that address.

In a further embodiment, the device receives an address request announcement from the other device. This address request announcement includes a first address that is a network layer address and the second address is a link layer address. An address request announcement associates the first and second addresses. The device further locates an address request record corresponding to the first and second addresses. This address request record stores this association and also includes a field to reference a reachability record for the second address.

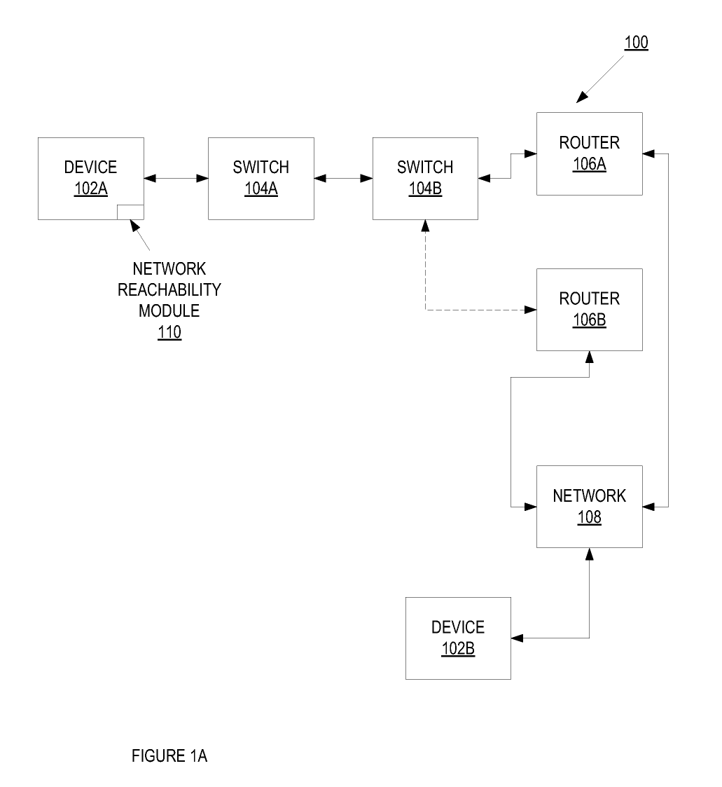

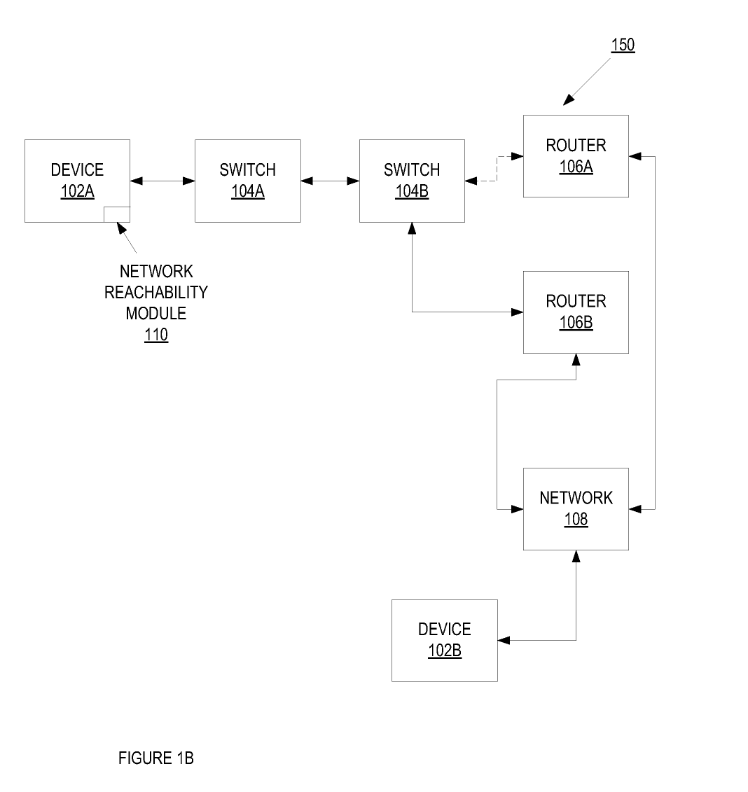

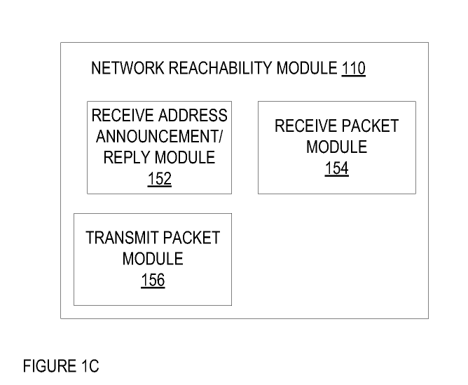

FIG. 1A is a block diagram of one embodiment of system 100 that is used to communicate packets from one device 102A to a remote device 102B. In FIG. 1A, device 102A communicates packets with remote device 102B via switches 104A-B and router 106A across network 108. In one embodiment, device 102A is coupled to switch 104A, which in turn is coupled to switch 104B. In this embodiment, switch 104B is coupled to routers 106A-B. Routers 106A-B are coupled to network 108. Remote device 102B is coupled to network 108.

In one embodiment, devices 102A-B are any type of device that can send and/or receive packet across a network. For example and in one embodiment, devices 102A-B can be a personal computer, server, laptops, palmtops, mobile phones, smartphones, multimedia phones, portable media players, GPS units, mobile gaming systems, etc. In one embodiment, switches 104A-B can be any type of device known in the art that forwards packets using the link layer information contained in the packets that the switches processes. In one embodiment, routers 106A-B can be any type of device known in the art that forwards packets using the network layer information contained in the packets that the router processes.

As illustrated in FIG. 1A, in one embodiment, device 102A communicates packets with remote device 102B via router 106A, as router 106A has an active connection between switch 104A and router 106A. An active connection means that the link between two devices is up and actively communicating data. For example and in one embodiment, an active connection between switch 104B and router 106A can communicate data. In this embodiment, the physical link between the switch 104B and router 106B may be physically connected, but the interface of this router 106B may not be active. In this embodiment, router 106B is a backup router that is used for silent failover of router 106A in case router 106A fails for any reason. To communicate with remote device 102B, device 102A requires a link layer address that can be used for packets destined for remote device 102B. If device 102A intends to transmit a packet to a device that is not on its neighboring list of known devices, such as device 102B, device 102A determines which gateway address to use for this device. For example and in one embodiment, device 102A would send out an address request for the network layer address corresponding to the gateway, router 106A. The router 106A would respond to the address request with a response identifying the link layer address that corresponds to the gateway address.

For example and in one embodiment, the following actions are undertaken for device 102A to communicate with remote device 102B. Device 102A determines that remote device 102B is not local, so device 102A attempts to resolve the link layer address for the gateway of device 102A, which is router 106A. Device 102A sends an address request for the link layer address that corresponds to the network layer address of router 106A. Router 106A receives this request and responds to the request with the link layer address of router 106A. Device 102A receives the address response from router 106A and transmits the packet to remote device 102B via router 106A. This packet will have the network layer address for remote device 102B and the link layer address of router 106A. In response to receiving the packet destined for remote device 102B, router 106A resolves the link layer address of remote device 102B by sending an address request for the link layer address of remote device 102B. Remote device 102B responds to this request with the link layer address of remote device 102B. Router 106A forwards the packet to remote device 102B using the network and link layer addresses as the destination addresses of the packet. Remote device 102B may reply to this packet by sending another packet to device 102A.

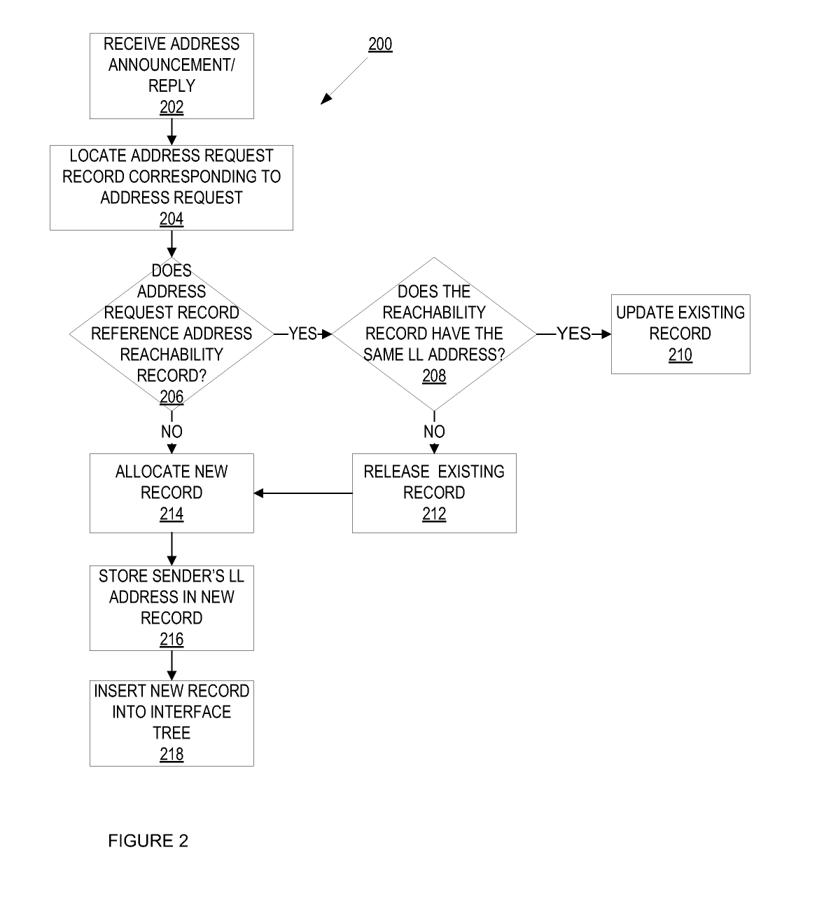

As described above, entries in the ARP table can expire over time. Once an entry has expired, device 102A broadcasts a new ARP request to get an updated MAC address for the IP address of the expired entry. Device 102A further includes network reachability module 110 that is described below in reference to FIGS. 1B and 2.

In one embodiment, a problem can arise if router 106A fails and router 106B silently takes the place of router 106A. As is known in the art, a silent failover is the ability to switch over automatically to a backup router upon the failure of the active router. In this embodiment, an active connection is activated between switch 104B and router 106B so that packets for device 106B can be communicated between switch 104B and router 106B. However, in this embodiment, after the failover, device 102A may continue to use the link layer address for router 106A for packets that are to be transmitted to remote device 102B until the association of the link layer to the network layer address for device 102B expires. By using the link layer addresses for router 106A, the packets will not be forwarded to remote device 102B because switches 104A-B will forward those packets to router 106A, which has failed.

FIG. 1B is a block diagram of one embodiment of system 150 that is used to communicate packets from one device 102A to remote device 102B after a switchover from one router 106A to another router 106B. In FIG. 1B, device 102A communicates packets with remote device 102B via switches 104A-B and router 106B across network 108. In one embodiment, device 102A is coupled to switch 104A, which in turn is coupled to switch 104B. In this embodiment, switch 104B is coupled to routers 106A-B. Routers 106A-B are coupled to network 108. Remote device 102B is coupled to network 108. Router 106B has the active connection to switch 104B instead of router 104A as is described in FIG. 1A. To detect the unreachability of a neighbor device (e.g., the failed router 106A), device 102A includes network reachability module 110. In one embodiment, network reachability module 110 is a module that tracks the reachability of link layer addresses based on a time that device 102A has received a packet from remote device 102B as well as other packets destined for device 102A. For example and in one embodiment, device 102A tracks packets sent and received from router 106A to determine if the link layer address associated with router 106A is still reachable. If this link layer address is not reachable, device 102A broadcasts an address request for the network layer address of remote device 102B to get an updated link layer address associated with router 106A as is described above.

In one embodiment, the router 106A fails and the router 106B silently takes over forwarding network traffic, where router 106B has the same network layer address as router 106A. In this embodiment, device 102A learns the link layer address to network layer address mapping for router 106B, by broadcasting an address request for the network layer address of the gateway for device 102A (e.g., router 106B). Router 106B may respond to the address request and device 102A learns the link layer address for router 106B.

The network reachability module 110 is based on the characteristic that much of network communications are bidirectional. For example and in one embodiment, network communications based on Transport Control Protocol (TCP)/Internet Protocol (IP) is bidirectional. In addition, network communications based on user datagram protocol (UDP) is formally unidirectional, but, in practice, applications based on UDP network communications tend to use UDP in a bidirectional fashion. For example and in one embodiment, voice and/or video communication applications that use UDP in a bidirectional fashion as media and control data will flow between the two or more devices that participate in that application. Thus, if device 102A sends a packet to remote device 102B, most likely device 102A will receive a packet from remote device 102B in return. In addition, there may be traffic from remote devices other than remote device 102B destined for device 102A.

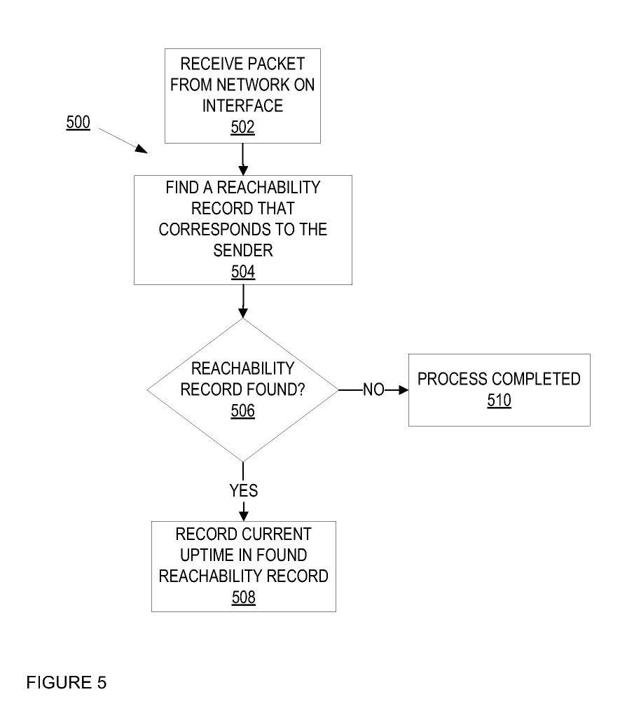

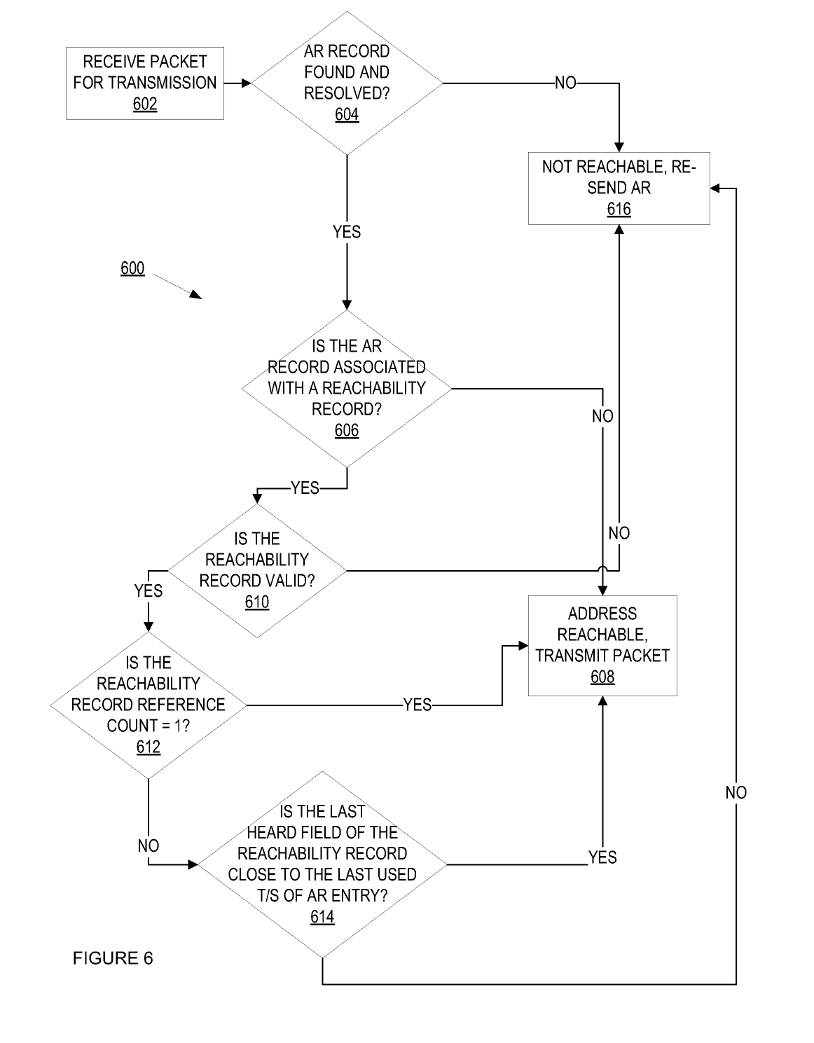

FIG. 1C is a block diagram of a network reachability module 110 that is used to monitor and detect the unreachability of neighbor devices. In one embodiment, network reachability module 110 tracks packets sent and received with other devices to determine if the link layer address of that other device is reachable. These other devices can be local devices on a local area network and/or remote devices separated by a router, such as remote device 106B. If the link layer address is unreachable, an address request is sent out to update the association of the link layer address with a corresponding network layer address. In one embodiment, network reachability module 110 includes receive address announcement/reply module 152, receive packet module 154, and transmit packet module 156. Receive address announcement/reply module 152 receives and processes address request packets as described in FIG. 2 below. Receive packet module 154 receives and processes non-address request packets as described in FIG. 5 below. Transmit packet module 156 transmits packets as described in FIG. 6 below.

FIG. 2 is a flow diagram of one embodiment of a process 200 to process address request announcements/replies received by a first device. In one embodiment, process 200 is used by device 102A to process received address request announcement/reply packets. Process 200 begins by receiving an address request announcement/reply at block 202. And as known in the art, an address request announcement or reply is a packet that contains information that associates a link layer address with a network layer address of the device transmitting the announcement. For example and in one embodiment, the address request announcement/reply packet is an ARP packet that associates a MAC address to an IP address of a given device. For example and in one embodiment, an address announcement packet is an ARP announcement that is used by a device to announce the association between the MAC and IP address of that device. In another embodiment, an address reply packet is an ARP reply that is sent by a device in response to an ARP request packet. This ARP reply packet is a packet a device that associates a MAC and IP address of that device. In an alternative embodiment, other protocols can be used to associate network layer and link layer addresses as known in the art (Neighbor Discovery Protocol (NDP), etc.).

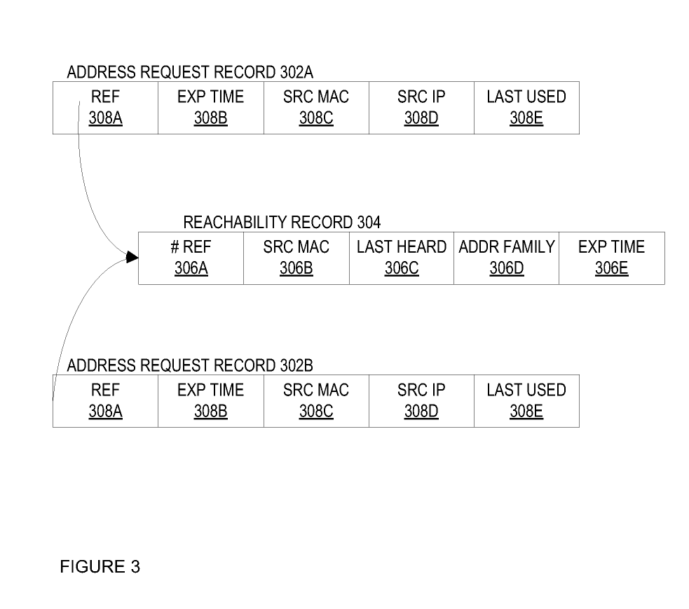

At block 204, process 200 locates an address request record corresponding to the addresses in the address request announcement/reply packet that was received at block 202. In one embodiment, process 200 searches a table by looking for an entry in the table that matches those addresses that were contained in the address request announcement/reply packet. If a current address request record is not found, process 200 may create a new address request record and proceed to block 206. For example and in one embodiment, process 200 searches an ARP table for an ARP entry that matches an MAC and IP address contained in a received ARP announcement/reply. An example of an address request record is described with reference to FIG. 3 below.

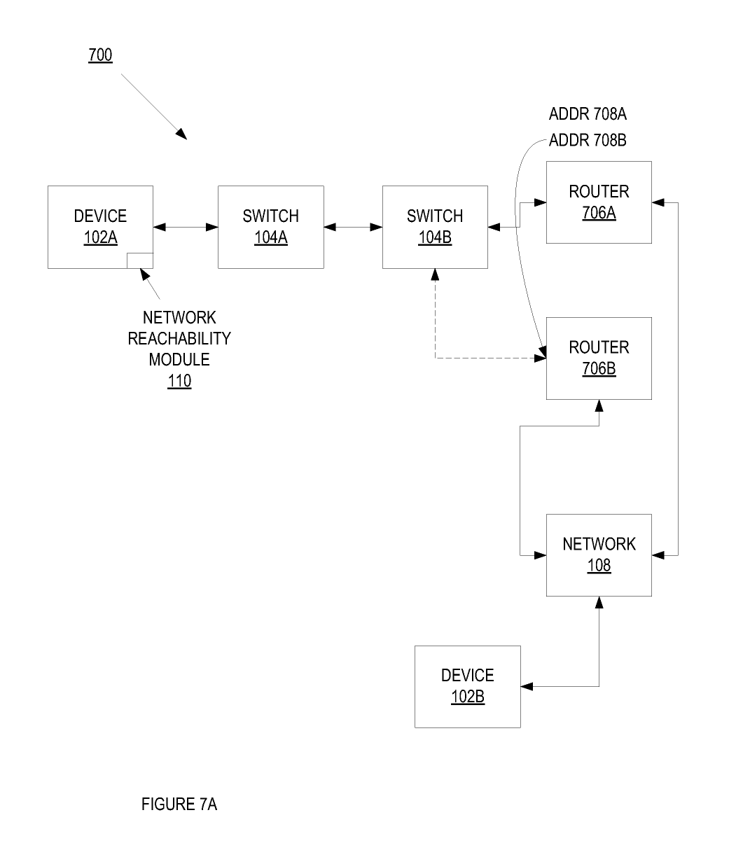

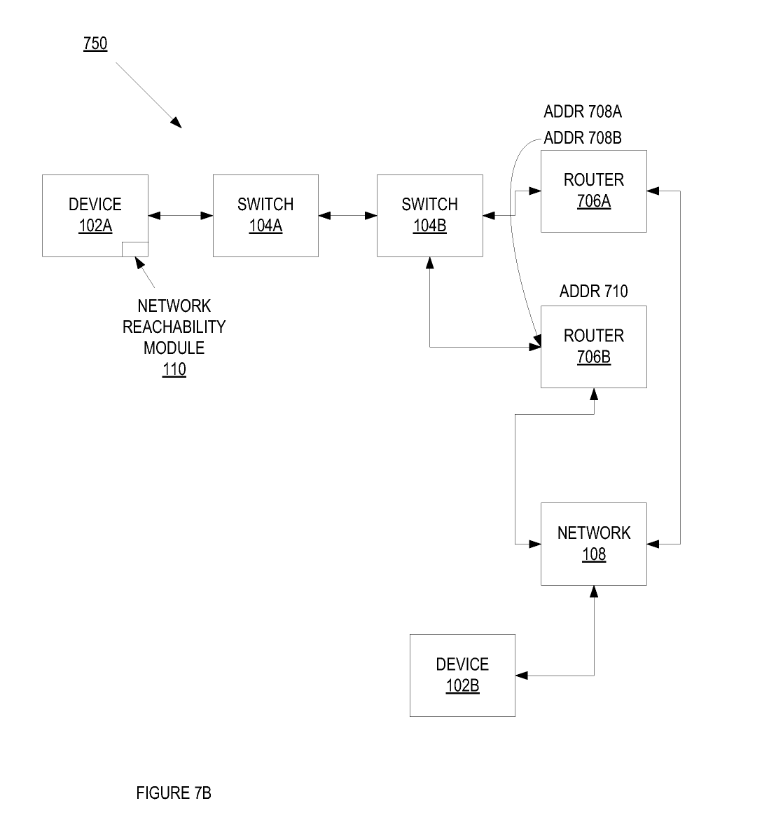

At block 206, process 200 determines if the address request record references a reachability record. In one embodiment, a reachability record is used to track the reachability of a link layer address. In this embodiment, each address request record references a reachability record for this tracking. In another embodiment, multiple address request records can reference one reachability record. In this embodiment, this can occur when multiple network layer addresses are assigned to the same network interface. For example and in one embodiment, a device can have multiple IP addresses for an interface that has a single MAC address. A router with multiple IP addresses assigned to an interface is illustrated in FIGS. 7AB below. An example of a reachability record is described with reference to FIG. 3 below.

If the address request record references an existing reachability record, at block 208, process 200 determines if the reachability record has same link layer address as the link layer address that is in the referencing address request record. For example and in one embodiment, process 200 may determine if the MAC address in an ARP entry references the same MAC address in a referenced reachability record. If this reachability record has the same link layer address, at block 210, process 200 updates the existing reachability record. In one embodiment, process 200 updates the probe count. In this embodiment, updating an existing record is used when multiple network address have the same link layer address.

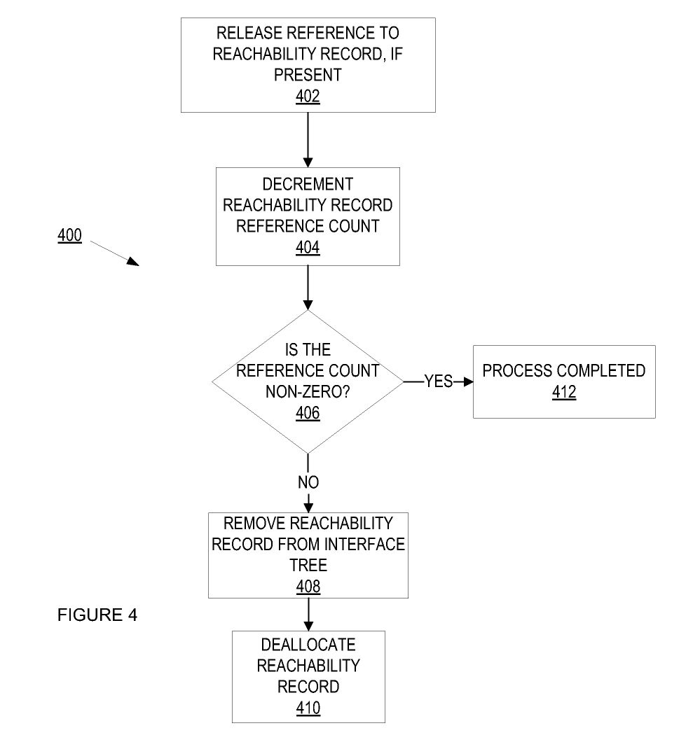

If the reachability record does not have the same link layer address in the address request record and the corresponding referenced reachability record, at block 212, process 200 releases the existing reachability record. For example and in one embodiment, a mismatch in the address request record and the referenced reachability record can occur when an IP address that has been assigned to a new MAC address. An example of address migration is described in FIG. 7A-B below. Releasing an existing reachability record is further described in FIG. 4 below. Execution proceeds to block 214.

If the address request record does not reference reachability record, or an existing reachability record is released, at block 214, process 200 allocates a new reachability record. In one embodiment, process 200 creates the reachability record and proceeds to block 216. For example and in one embodiment, process 200 allocates memory for the reachability record and stores a reference to the newly allocated reachability record in the corresponding address request record. In another embodiment, process 200 searches an interface tree for the interface that received the address announcement/reply packet for a reachability record that matches the link layer address. If there is a match, process 200 increases the reference count for that link layer address is incremented.

At block 216, process 200 stores the sender's link layer address in the new reachability record. For example and in one embodiment, the sender's MAC address is stored in field 306B of the reachability record 304 as shown as illustrated in FIG. 3 below. At block 218, process 200 inserts this newly allocated reachability record into an interface tree. In one embodiment, there is an interface tree for each interface on the device. In one embodiment, process 200 inserts the new reachability record into a red-black tree for the interface. As known in the art, a red-black tree is a type of self-balancing search tree. In one embodiment, there is a red-black tree for each network interface of a device. In this embodiment, each interface tree is used for searching for reachability records when packets are received in FIG. 5 below. In another embodiment, the reachability records are stored in an alternate data structure as known in the art (e.g., radix trie, standalone structure, etc.).

As described above, an address request record includes a field that can reference a reachability record. In addition, multiple address request structures can reference the same reachability record. FIG. 3 is a block diagram of multiple address request records 302A-B that reference a reachability record 304. While in one embodiment, the address request record 302A-B is a modified ARP entry in an ARP table, in alternate embodiment, the address request records is another structure (e.g., modified NDP table entry, separate structure, etc.). This record is used to associate a source network layer address with the source link layer address. In one embodiment, an address request record includes fields found an ARP entry, namely expiration time field 308B, source MAC address 308C, and source IP address 308D. In one embodiment, expiration time 308B includes a time when the association between the link layer and network layer address becomes invalid. After this time, a transmitting device needs to renew this association by sending an address request packet to determine the link layer address associated with a given network layer address. Source MAC address field 308C stores the link layer address for this record (e.g., a MAC address). Source IP address field 308D stored the network layer address for this record (e.g., an IP address).

In addition, address request record 302A-B includes additional fields not normally found in an ARP entry, namely, the reference field 308A and last used field 308E. In one embodiment, the reference field 308A is used to reference a reachability record that corresponds to the link layer address stored in the source MAC field 308C. The referenced reachability record 304 is used to track the last time that a packet with that source link layer address address stored in the reachability record was received by a device. In another embodiment, the address request record 302A-B can include additional fields as known in the art. In one embodiment, last used field 308E is used to store the last time a device transmits a packet to the corresponding to the link layer address stored in field 308C.

In one embodiment, the reachability record 304 includes fields 306A-E. These fields include number of references 306A, source MAC field 306B, last heard field 306C, address family field 306D, and expiration time 306E. In one embodiment, number of references field 306A stores the number of address request records 302A-B that reference this reachability record. As is illustrated in FIG. 3, the reference count stored in the number of references field would be two, as there are two address request records 302A-B that reference this reachability record 304. In alternate embodiment, there can be more or less address request records that reference a reachability record. Source MAC field 306B stores the source link layer address for this reachability record (e.g., a MAC address). Last heard field 306C stores a timestamp for the last time that a packet with the link layer address stored in the source MAC address was received by that device. Address family field 306D is used to store a key that is unique to an address family, such as an address for IPv4 or IPv6. In one embodiment, an address family is a set of addresses related by protocol (IPv4, IPv6, etc.). For example and in one embodiment, a particular reachability record of device 102A created by a received address announcement/reply packet is shared by one or more address request entries, because the address family is that of IPv4. If IPv6 communication needs to be established to or through device 102A, another reachability record for device 102A is created and is associated with the corresponding IPv6 ND (Neighbor Discovery) entry. The difference between these two reachability records would be the “address family” field. For example and in one embodiment, IPv4 is indicated by the key ETHERTYPE_IP and IPv6 is indicated by the key ETHERTYPE_IPV6. These records are stored in the same interface tree (e.g., an red-black tree of the interface). In this embodiment, it is possible to have the different reachability records, since each key is unique (the “address family” is part of the key) even though they both refer to the same MAC address of device 102A. In one embodiment, expiration time 306E stores an expiration time for the reachability record. This time is stored when the reachability record is created. For example and in one embodiment, when a reachability record is created, a random time between 15-45 seconds is stored in the expiration time field 308E. In another embodiment, this time can be a random time that chosen from a smaller or larger range, or can be a fixed time within or outside the 15-45 second range. In one embodiment, this field is used to determine if the last heard field 306C of a reachability record 304 is close to the last used field 308E of an address request record 302A-B as described below in FIG. 6.

FIG. 4 is a flow diagram of one embodiment of a process 400 to release a reachability record. Process 400 begins by releasing a reference to the address reachability record at block 402. In one embodiment, process 400 stores a null value in the reachability record reference field of an address request record. In this embodiment, this severs the link between the address request record and the reachability record. At block 404, process 400 decrements the number of the reference count. In one embodiment, process 400 subtracts one from the current value stored in the number of references in the reachability record. For example, process 400 subtracts one from the number of reference field 306A of reachability record 304 as described above in FIG. 3.

At block 406, process 400 determines if the reference count is nonzero. In one embodiment, process 400 evaluates the value stored in the number reference field 306A of the reachability record 304 as described above in FIG. 3. If the reference count is nonzero, at block 412, the process of process 400 is completed. If the reference count is zero at block 408, process 400 removes the reachability record from the interface tree. In one embodiment, process 400 severs the link between the reachability record and the red-black tree for the interface as known in the art. At block 410, process 400 de-allocates the reachability record, which frees the memory for other uses.

As described above, FIGS. 2 and 4 describe processing of address request packets and incorporating the information in these packets into address request table, where each record in this table includes a reference is to a corresponding reachability record to track the reachability of the source of link layer address. FIGS. 5 and 6 described below described using the address request table and reachability records to receive and transmit packets. For receiving packets, a device updates the last heard field, in the reachability record for that link layer address. This is further described in the FIG. 5 below. For transmitting packets, a device uses the address request record and corresponding reachability record to determine if the destination address is still reachable. This is further described in the FIG. 6 below.

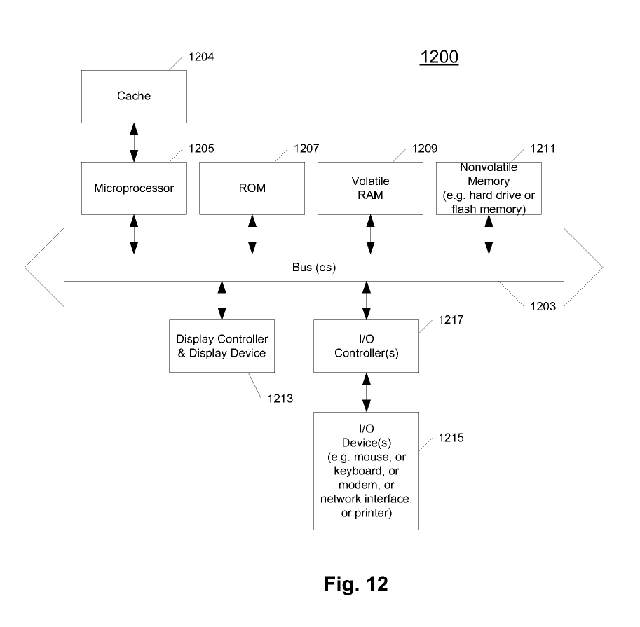

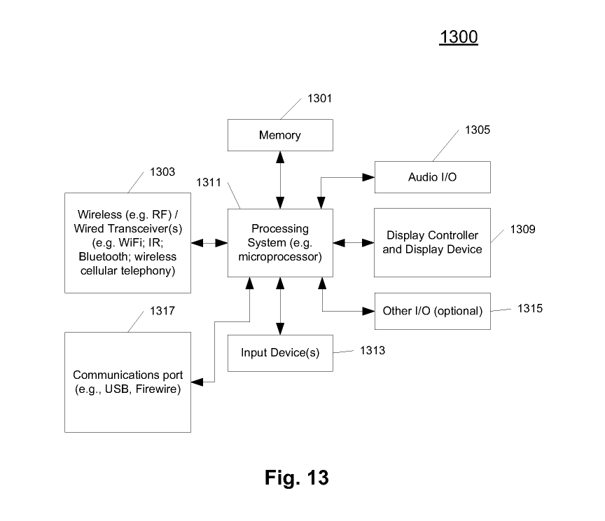

FIG. 5 is a flow diagram of one embodiment of a process to receive a packet. Process 500 begins at block 502 by receiving a packet from a network on interface. For example and in one embodiment, interface is interface 1215 or 1315 as illustrated in FIGS. 12 and 13, respectively. In one embodiment, process 500 may receive packets over any number of transport mediums as known in the art (for example, Ethernet, ATM, wireless, cellular data, etc.). At block 504, process 500 finds a reachability record in interface tree that corresponds to the sender. In one embodiment, process 500 compares the link layer address stored in the packet received on the interface with the reachability record to determine if a reachability record for that interface exists for that link layer address. In one embodiment, if the same link layer address is received on different interfaces, a different reachability record is employed on each interface tree for the corresponding interfaces. At block 506, process 500 determines if the reachability record was found. If the reachability record is not found, process 500 is completed. If the reachability record is found, process 500 stores the current uptime in the found reachability record at block 508. In one embodiment, the uptime is the system uptime, which is used as an ever-increasing number that represents the number of seconds since the system started. For example and in one embodiment, process 500 stores the current uptime in the last heard field 306C of the reachability record 304 as described above in FIG. 3.

FIG. 6 is a flow diagram of one embodiment of a process 600 to transmit a packet using the address request and reachability records. FIG. 6 begins by process 600 receiving a packet transmission. In one embodiment, the received packet is placed in the queue for transmission. At block 604, process 600 determines if the destination network and link layer addresses in the packet can be found and is resolved in the address request records. If not, at block 616, process 600 determines that the address found in this packet is not reachable and re-sends an address request. In this embodiment, process 600 sends the address request to determine a link address for the destination network layer address found in the packet. For example and in one embodiment, process 600 broadcasts an ARP request to neighboring device(s) to determine a MAC address for a corresponding IP address.

At block 606, process 600 determines if address request record is associated with a reachability record. In one embodiment, process 600 interrogates reference field 308A of the address request record to determine if this address request record references an existing reachability record. If the address request record does not point to an existing reachability record, process 600 pretends that the address is reachable and transmits the packet at block 608. In one embodiment, process 600 may transmit this packet over any number of transport mediums as known in the art (for example, Ethernet, ATM, wireless, cellular data, etc.).

If the address request record does reference an existing reachability record at block 606, process 600 determines if the reachability record is valid at block 608. In one embodiment, process 600 determines the validity of the reachability record by determining if process 600 has heard from the remote device associated with the reachability record within a certain time limit. In one embodiment, the time limit is based on the time stored in last used record and a random value between 15-45 seconds. In one embodiment, each reachability record is created with a different limit, with this limit within the range of 15-45 seconds. For example and in one embodiment, process 600 compares the current time with a timestamp stored in the last used record of that reachability record. If the time differences is outside the limit, process 600 determines this link layer address is unreachable and re-sends an address request at block 616, as described above.

If this time difference is within the limit, execution proceeds to block 612. At block 612, process 600 determines if the number of address request references to the reachability record corresponding to the received packet is equal to one. If the number of address request references for the reachability record is one, process 600 determines that network layer address is reachable and transmits the packet at block 608 as described above. If the number of address request references for the reachability record is greater than one, at block 614, process 600 determines if the timestamp in last used record is close to the timestamp in the last received record. In one embodiment, close timestamps are within a range between 15-45 seconds. In one embodiment, the closeness value is set as a random number between 15-45 seconds and is stored in the expiration field of the reachability record, such as the expiration field 306E of reachability record 304 as described in FIG. 3 above. If the timestamp in last used and last received records are close, process 600 determines the address is reachable and transmits the packet at block 608 as described above. If the timestamp in last used record is not close to the timestamp in the last received record, process 600 determines that the address is not reachable and resends an address request to get an updated association to network layer address and the link layer address at block 616 as described above.

FIG. 7A is a block diagram of one embodiment of system 700 that is used to communicate packets from one device after an address migration from one router to another router. In FIG. 1B, device 102A communicates packets with remote device 102B via switches 104A-B and router 706A across network 108. In one embodiment, device 102A is coupled to switch 104A, which in turn is coupled to switch 104B. In this embodiment, switch 104B is coupled to routers 706A-B. Routers 706A-B are coupled to network 108. Remote device 102B is coupled to network 108. Router 706A has the active connection to switch 104B. To detect the migration of address(es), device 102A includes network reachability module 110 as described above with reference to FIG. 1B above.

In FIG. 7A, router 706A includes two addresses (addresses 708A-B) on the interface that couples router 706A to switch 104B. In one embodiment, each of these addresses is a network layer address (e.g., IP address) that corresponds to a link layer address (e.g., MAC address) for the interface that couples router 706A to switch 104B. In one embodiment, one of the network layer addresses 708B silently migrates from router 706A to router 706B. In this embodiment, the address request record information may become out of date as address 708B is associated with a new link layer address. In this embodiment, device 102A uses network reachability module 110 to detect that address 708B is associated with another link layer address.

FIG. 7B is a block diagram of one embodiment of system that is used to communicate packets from one device after an address migration from one router to another router, where the backup router is active. In FIG. 1B, device 102A communicates packets with remote device 102B via switches 104A-B and router 706A across network 108. In one embodiment, device 102A is coupled to switch 104A, which in turn is coupled to switch 104B. In this embodiment, switch 104B is coupled to routers 706A-B. Routers 706A-B are coupled to network 108. Remote device 102B is coupled to network 108. Router 706A has the active connection to switch 104B. To detect the migration of address(es), device 102A includes network reachability module 110 as described above with reference to FIG. 1B above.

In FIG. 7B, each router 706A-B has an active connection between router 706A-B and switch 104B. As in FIG. 7A above, router 706A includes two addresses (addresses 708A-B) on the interface that couples router 706A to switch 104B. Furthermore, router 706B include address 710 that is used to communicate packets between router 708B and switch 104B. In one embodiment, each of these addresses is a network layer address (e.g., IP address) that corresponds to a link layer address (e.g., MAC address) for the interface that couple routers 706A-B to switch 104B. In this embodiment, one of the network layer addresses 708B silently migrates from router 706A to router 706B. In this embodiment, the address request record information may become out of date as address 708B is associated with a new link layer address. In this embodiment, device 102A uses network reachability module 110 to detect that address 708B is associated with another link layer address.

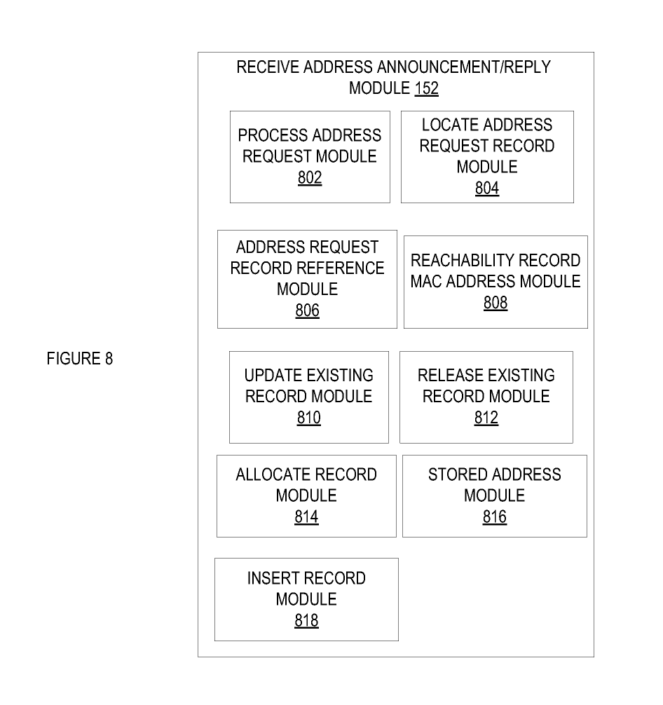

FIG. 8 is a block diagram of one embodiment of a receive address announcement/reply module 152 to process received address requests. In one embodiment, receive address announcement/reply module 152 includes process address request module 802, locate address request record module 804, address request record reference module 806, reachability record MAC address module 808, update existing record module 810, release existing record module 812, allocate record module 814, stored address module 816, and insert record module 818. In one embodiment, process address request module 802 processes received address requests as described above with respect to FIG. 2, block 202. In one embodiment, locate address request record module 804 locates as described above with respect to FIG. 2, block 204. In one embodiment, address request record reference module 806 determines if an address request record references a reachability record as described above with respect to FIG. 2, block 206. In one embodiment, reachability record MAC address module 808 determines if the reachability record has the same MAC address as described above with respect to FIG. 2, block 208. In one embodiment, update existing record module 810 updates an existing reachability record as described above with respect to FIG. 2, block 210. In one embodiment, release existing record module 812 releases an existing reachability record as described above with respect to FIG. 2, block 212. In one embodiment, allocate record module 814 allocates a new reachability record as described above with respect to FIG. 2, block 214. In one embodiment, stored address module 816 stores the sender's MAC address in a new record as described above with respect to FIG. 2, block 216. In one embodiment, insert record module 818 inserts a new record into an interface tree as described above with respect to FIG. 2, block 218.

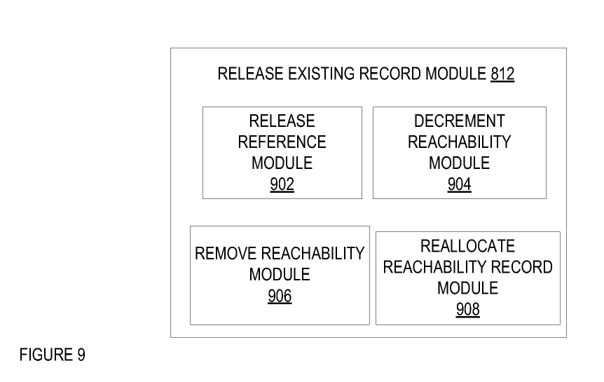

FIG. 9 is a block diagram of one embodiment of a release existing record module 812 to release an existing reachability record. In one embodiment, release existing record module 812 includes release reference module 902, decrement reachability module 904, remove reachability module 906, and reallocate reachability record module 908. In one embodiment, release reference module 902 releases a reference to a reachability record as described with reference to FIG. 4, block 402 above. In one embodiment, decrement reachability module 904 decrements a reachability record reference count as described with reference to FIG. 4, block 404 above. In one embodiment, remove reachability module 906 removes a reachability record as described with reference to FIG. 4, block 408 above. In one embodiment, deallocate reachability record module 908 deallocates a reachability record as described with reference to FIG. 4, block 410 above.

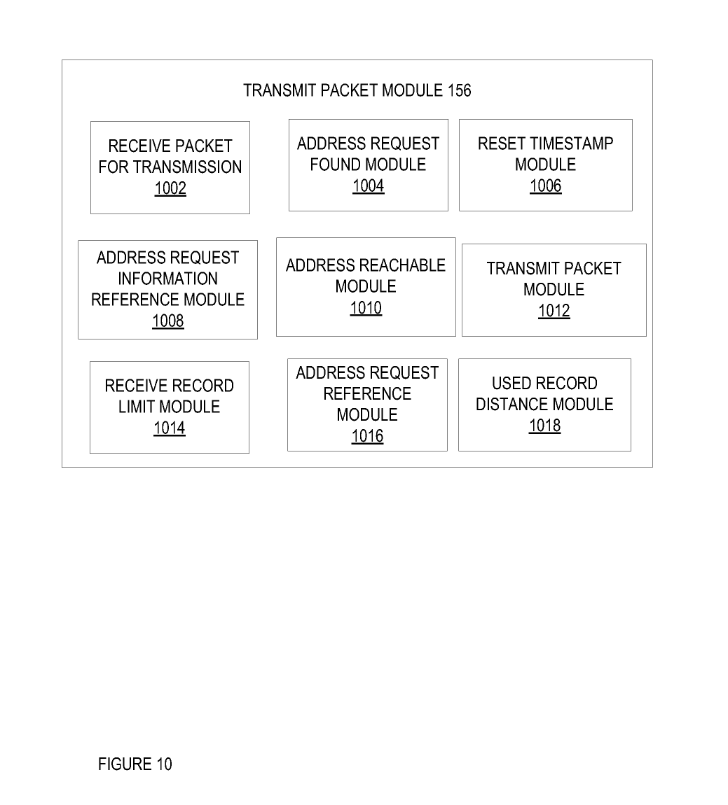

FIG. 10 is a block diagram of one embodiment of a transmit packet module 156 to transmit packets. In one embodiment, transmit packet module 156 includes receive packet for transmission module 1002, address request found module 1004, reset timestamp module 1006, address request information reference module 1008, address reachable module 1010, transmit packet module 1012, receive record limit module 1014, address request reference module 1016, and user record distance module 1018. In one embodiment, receive packet for transmission module 1002 receives a packet for transmission as described with reference to FIG. 6, block 602 above. In one embodiment, address request found module 1004 determines if an address request record is found as described with reference to FIG. 6, block 604 above. In one embodiment, reset timestamp module 1006 resets the timestamp in an address request record as described with reference to FIG. 6, block 606 above. In one embodiment, address request information reference module 1008 determines if an address request record references a reachability record as described with reference to FIG. 6, block 608 above. In one embodiment, address reachable module 1010 as described with reference to FIG. 6, block 602 above. In one embodiment, transmit packet module 1012 transmits a packet as described with reference to FIG. 6, block 612 above. In one embodiment, receive record limit module 1014 determines if last used record is within a limit as described with reference to FIG. 6, block 614 above. In one embodiment, address request reference module 1016 determines the number of references as described with reference to FIG. 6, block 616 above. In one embodiment, used record distance module 1018 determines if the last used record is within a reasonable distance as described with reference to FIG. 6, block 618 above.

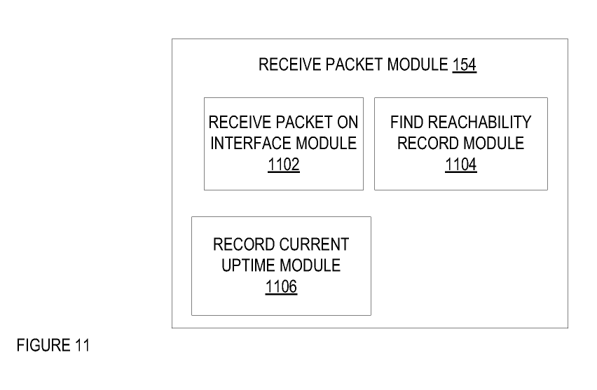

FIG. 11 is a block diagram of one embodiment of a receive packet module 154 to process received packets. In one embodiment, receive packet module 154 includes receive packet on interface module 1102, find reachability record module 1104, and record current uptime module 1106. In one embodiment, receive packet on interface module 1102 receives packet on an interface as described with reference to FIG. 5, block 502 above. In one embodiment, find reachability record module 1104 finds a reachability record as described with reference to FIG. 5, block 504 above. In one embodiment, record current uptime module 1106 records a current uptime as described with reference to FIG. 5, block 508 above.

FIG. 12 shows one example of a data processing system 1200, which may be used with one embodiment of the present invention. For example, the system 1200 may be implemented including a device 102A-B as shown in FIG. 1. Note that while FIG. 12 illustrates various components of a computer system, it is not intended to represent any particular architecture or manner of interconnecting the components as such details are not germane to the present invention. It will also be appreciated that network computers and other data processing systems or other consumer electronic devices, which have fewer components or perhaps more components, may also be used with the present invention.

As shown in FIG. 12, the computer system 1200, which is a form of a data processing system, includes a bus 1203 which is coupled to a microprocessor(s) 1205 and a ROM (Read Only Memory) 1207 and volatile RAM 1209 and a non-volatile memory 1211. The microprocessor 1205 may retrieve the instructions from the memories 1207, 1209, 1211 and execute the instructions to perform operations described above. The bus 1203 interconnects these various components together and also interconnects these components 1205, 1207, 1209, and 1211 to a display controller and display device 1213 and to peripheral devices such as input/output (I/O) devices which may be mice, keyboards, modems, network interfaces, printers and other devices which are well known in the art. Typically, the input/output devices 1215 are coupled to the system through input/output controllers 1217. The volatile RAM (Random Access Memory) 1209 is typically implemented as dynamic RAM (DRAM), which requires power continually in order to refresh or maintain the data in the memory.

The mass storage 1211 is typically a magnetic hard drive or a magnetic optical drive or an optical drive or a DVD RAM or a flash memory or other types of memory systems, which maintain data (e.g. large amounts of data) even after power is removed from the system. Typically, the mass storage 1211 will also be a random access memory although this is not required. While FIG. 12 shows that the mass storage 1211 is a local device coupled directly to the rest of the components in the data processing system, it will be appreciated that the present invention may utilize a non-volatile memory which is remote from the system, such as a network storage device which is coupled to the data processing system through a network interface such as a modem, an Ethernet interface or a wireless network. The bus 1203 may include one or more buses connected to each other through various bridges, controllers and/or adapters as is well known in the art.

FIG. 13 shows an example of another data processing system 1300 which may be used with one embodiment of the present invention. For example, system 1300 may be implemented as a device 102A-B as shown in FIG. 1. The data processing system 1300 shown in FIG. 13 includes a processing system 1311, which may be one or more microprocessors, or which may be a system on a chip integrated circuit, and the system also includes memory 1301 for storing data and programs for execution by the processing system. The system 1300 also includes an audio input/output subsystem 1305, which may include a microphone and a speaker for, for example, playing back music or providing telephone functionality through the speaker and microphone.

A display controller and display device 1309 provide a visual user interface for the user; this digital interface may include a graphical user interface which is similar to that shown on a Macintosh computer when running OS X operating system software, or Apple iPhone when running the iOS operating system, etc. The system 1300 also includes one or more wireless transceivers 1303 to communicate with another data processing system, such as the system 1300 of FIG. 13. A wireless transceiver may be a WLAN transceiver, an infrared transceiver, a Bluetooth transceiver, and/or a wireless cellular telephony transceiver. It will be appreciated that additional components, not shown, may also be part of the system 1300 in certain embodiments, and in certain embodiments fewer components than shown in FIG. 13 may also be used in a data processing system. The system 1300 further includes one or more communications ports 1317 to communicate with another data processing system, such as the system 1500 of FIG. 15. The communications port may be a USB port, Firewire port, Bluetooth interface, etc.

The data processing system 1300 also includes one or more input devices 1313, which are provided to allow a user to provide input to the system. These input devices may be a keypad a keyboard or a touch panel or a multi touch panel. The data processing system 1300 also includes an optional input/output device 1315 which may be a connector for a dock. It will be appreciated that one or more buses, not shown, may be used to interconnect the various components as is well known in the art. The data processing system shown in FIG. 13 may be a handheld computer or a personal digital assistant (PDA), or a cellular telephone with PDA like functionality, or a handheld computer which includes a cellular telephone, or a media player, such as an iPod, or devices which combine aspects or functions of these devices, such as a media player combined with a PDA and a cellular telephone in one device or an embedded device or other consumer electronic devices. In other embodiments, the data processing system 1300 may be a network computer or an embedded processing device within another device, or other types of data processing systems, which have fewer components or perhaps more components than that shown in FIG. 13.

At least certain embodiments of the inventions may be part of a digital media player, such as a portable music and/or video media player, which may include a media processing system to present the media, a storage device to store the media and may further include a radio frequency (RF) transceiver (e.g., an RF transceiver for a cellular telephone) coupled with an antenna system and the media processing system. In certain embodiments, media stored on a remote storage device may be transmitted to the media player through the RF transceiver. The media may be, for example, one or more of music or other audio, still pictures, or motion pictures.

The portable media player may include a media selection device, such as a click wheel input device on an iPod® or iPod Nano® media player from Apple, Inc. of Cupertino, Calif., a touch screen input device, pushbutton device, movable pointing input device or other input device. The media selection device may be used to select the media stored on the storage device and/or the remote storage device. The portable media player may, in at least certain embodiments, include a display device which is coupled to the media processing system to display titles or other indicators of media being selected through the input device and being presented, either through a speaker or earphone(s), or on the display device, or on both display device and a speaker or earphone(s). Examples of a portable media player are described in published U.S. Pat. No. 7,345,671 and U.S. published patent number 2004/0224638, both of which are incorporated herein by reference.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “receiving,” “setting,” “transmitting,” “locating,” “storing,” “inserting,” “transferring”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A non-transitory machine-readable medium having executable instructions to cause one or more processing units to perform a method to transmit a packet from a first device to a second device, the method comprising:
receiving the first packet for transmission to a second device, wherein the first packet includes a first address of the second device; and
determining if that first address is reachable based on a time the first device has received a second packet from the second device.

2. The non-transitory machine-readable medium of claim 1, wherein the determining if the address is reachable comprises:
determining if the first address is associated with a second address;
if the first address has the associated second address,
retrieving an address request record that associates the second address to the first address, and
setting a transmission timestamp to a current time in the address request record.

3. The non-transitory machine-readable medium of claim 2, wherein the determining if the address is reachable further comprises:
if there is not the associated second address, sending an address request for the first address.

4. The non-transitory machine-readable medium of claim 2, wherein the first address is a network address and the second address is a link layer address.

5. The non-transitory machine-readable medium of claim 4, wherein the first address is an Internet Protocol address and the second address is Media Access Control address.

6. The non-transitory machine-readable medium of claim 2, wherein the second address is a link layer address of a forwarding device that forwards the packet to the second device.

7. The non-transitory machine-readable medium of claim 2, the determining if the address is reachable further comprises:
determining if the address record references a reachability record for the second address, wherein the reachability record includes a timestamp of a last time a second packet was received from the second device; and
transmitting the first packet if the received timestamp for the second address is within a time limit.

8. The non-transitory machine-readable medium of claim 1, wherein the method further comprises:
receiving a second packet from the second device, wherein the second device includes a third address of the second device.

9. The non-transitory machine-readable medium of claim 8, wherein the method further comprises:
determining if a reachability record exists for the third address of the second packet; and
if the reachability record is found, recording the current time in the last used field of the reachability record.

10. A non-transitory machine-readable medium having executable instructions to cause one or more processing units to perform a method to process a received address request from a second device by a first device, the method comprising:
receiving an address request from the second device, wherein the address request includes a first address that is a network layer address and the second address is a link layer address; and
locating an address request record corresponding to the first and second addresses, wherein the address request record includes a field to reference a reachability record for the second address.

11. The non-transitory machine-readable medium of claim 10, wherein the reachability record includes a field to record a last time a packet from the second device was received by the first device.

12. The non-transitory machine-readable medium of claim 10, wherein the first address is a network address and the second address is a link layer address.

13. The non-transitory machine-readable medium of claim 10, wherein the first address is an Internet Protocol address and the second address is Media Access Control address.

14. The non-transitory machine-readable medium of claim 10, wherein the method further comprises:
if the field references the reachability record, updating the reachability record with a number of address request records that reference the reachability record.

15. The non-transitory machine-readable medium of claim 10, wherein the method further comprises:
if the field does not reference the reachability record,
allocating a new reachability record,
storing the second address in the new reachability record, and
inserting the new reachability record into an interface tree.

16. An apparatus comprising:
means for receiving a first packet for transmission to a second device, wherein the first packet includes an address of the second device; and
means for determining if that address is reachable based on a time the first device has received a second packet from the second device.

17. The apparatus of claim 16, wherein the means for determining if the address is reachable comprises:
means for determining if the first address is associated with a second address;
if the first address has the associated second address,
means for retrieving an address request record that associates the second address to the first address, and
means for setting a transmission timestamp to a current time in the address request record.

18. The apparatus of claim 17, wherein the means for determining if the address is reachable further comprises:
if there is not the associated second address, means for sending an address request for the first address.

19. The apparatus of claim 17, wherein the means for determining if the address is reachable further comprises:
means for determining if the address record references a reachability record for the second address, wherein the reachability record includes a timestamp of a last time a second packet was received from the second device; and
means for transmitting the first packet if the received timestamp for the second address is within a time limit.

20. The apparatus of claims 16, wherein the apparatus further comprises:
means for receiving a second packet form the second device, wherein the second device includes a third address of the second device.
